(19) United States
(12) Patent Application Publication
(10) Pub. No.: US 2008/0087607 A1
(43) Pub. Date: Apr. 17, 2008

(54) Effluent Treatment Installation And Clarification And Filtration Method Using Same

(76) Inventors: Chrystelle Langlais, Le Pecq (FR); Veronique Bonnelye, Conflans Ste Honorine (FR)

Correspondence Address: SUGHRUE MION, PLLC, 2100 PENNSYLVANIA AVENUE, N.W., SUITE 800, WASHINGTON, DC, 20037, US

(21) Appl. No.: 11/662,651

(22) PCT Filed: Aug. 12, 2005
(86) PCT No.: PCT/FR05/02085

§ 371 Date: Mar. 13, 2007

(30) Foreign Application Priority Data
Sep. 15, 2004 (FR) 0409763

(51) Int. Cl. B01D 21/00; B01D 21/01; C02F 1/52

(52) U.S. Cl. 210/704; 210/359; 210/703

(57) ABSTRACT

The invention relates to an effluent treatment installation which can be used to improve the filtration capacity of membranes and to reduce water losses without increasing the floor area thereof. For said purpose, the invention comprises a pulsed sludge blanket settling tank (1) containing membrane filtration modules (10) which are submerged in or above the sludge blanket, and the system (11) for extracting the treated effluents is connected upstream of said filtration modules (10). The invention also relates to a method for clarification by means of coagulation/flocculation/decantation and for filtration using said installation.

The invention relates to an effluent treatment installation and to a clarification and filtration method using said installation.

More particularly, the invention relates to the treatment installations for clarification by means of coagulation/flocculation/settling and for membrane filtration of effluents, in particular of water.

The filtration membranes (micro-, nano-, ultra- and hyperfiltration) make it possible to remove all the particles whose diameter is greater than the size of the membrane pores, and a part of the dissolved fraction when the size of the molecules is greater than the cut-off threshold of the membrane.

Used alone, membrane filtration runs the risk of substantial fouling by virtue of the suspended-matter (SM), colloidal-matter and dissolved-matter content of the raw supply water: the design flow of membrane treatment installations is limited by the fouling capacity of the water and the use of installations thus designed is subject to difficulties and to a lack of reliability related to fluctuations in the quality of the water to be filtered.

Furthermore, the colloidal and dissolved matters that pass through the membrane during the filtration step can, according to the quality of the raw water, reach concentrations in the filtered water that do not conform to the quality limits set by the regulations in relation to water intended for human consumption and by users who have specific quality requirements, in particular in industry.

It is for this reason that membrane clarification methods must, in many cases, be combined with other treatments, in particular coagulation pretreatment methods.

A solution consists in providing for, upstream of a membrane filtration installation, an installation for preclarification by means of coagulation/flocculation with gravity separation (by settling or flotation) of the vast majority of the coagulant and hydroxide precipitates. Such a coupling makes it possible to decrease the particle load reaching the membrane, the coagulation and the adsorption carried out in the pretreatment installation removing the colloidal matter and part of the dissolved matter.

In this case, the coupling is carried out by a simple juxtaposition of two treatment installations, the gravity separator and the submerged or pressurized membrane reactor, which requires a considerable floor area.

In addition, the filtration flow design of the membrane reactor is based on a low concentration of suspended matter, related to the performance levels of the gravity separation installation located upstream, and is therefore sensitive to any degradation of the function of the latter. In particular, an increase in the concentration of suspended matter may, depending on the effectiveness of the membrane antifouling system, generate complete blocking of the filtration system. Similarly, if the amount of treatment with coagulant is inadequate (overdosage or underdosage) in relation to the pollution to be treated, this results in an increase in the fouling capacity of the interstitial water. This increase occurs in particular when a flocculation adjuvant is used in the gravity separator in order to improve the performance levels thereof, and can generate deep fouling of the membrane due to the residual concentration of flocculation adjuvant.

All these dysfunctions make the coagulation—gravity separation—membrane filtration method one that is difficult to exploit and that operates randomly and relatively unreliably, generating high running costs, induced by an overconsumption of chemical washing reagents for the membranes and of energy, and also an increase in the amount of time that production installations are off-line.

A variant consists in carrying out a direct coagulation on housed or submerged membranes as described in document EP-1 239 943. The coagulant reagent is then injected into the water to be treated, and the water to be treated—coagulant mix is filtered directly over the membrane submerged in the reactor containing the water to be treated. In this case, a small amount of injected coagulant makes it possible to avoid deep and irreversible fouling of the membranes. The floor area of the installation is then reduced by a factor of 2 or 3 compared to the previous solution. However, a heterogeneity is observed in the concentration of suspended matter in the reactor, which generates an imbalance in the operating of the submerged membrane filtration modules that may, in the long term, induce excessive fouling and an increase in antifouling processes. In addition, the concentration of extraction of the sludge formed is generally identical to the concentration of sludge in the reactor. Now, due to the operating limit of the membranes, related to the maximum mass flux according to the relationship:
mass flux=concentration of SM×J_{F}, (1)

(J_{F}: filtration flux),

the concentration of sludge in the reactor is limited by an economically acceptable membrane filtration flux. The extraction of the sludge is thus carried out with a high extraction flow rate, of the order of 5 to 15% of the system supply flow rate, which generates high water losses and also high running costs, firstly, for the membrane filtration installation in terms of consumption of reagents and of energy and, secondly, for the post-treatment installation necessary for thickening the sludge. A conversion rate, which is the ratio of the flow rate of filtered water to the flow rate of raw water that enters, of the order of 85 to 95% is then obtained.

U.S. Pat. No. 4,756,644 A, which belongs to the applicant, discloses, moreover, a sludge blanket settling device, comprising a settling bath, equipped at its base with a device for dispensing the liquid to be treated, this device being equipped with a pulsed liquid feed system and a system for evacuation of the liquid treated. The liquid to be treated circulates from bottom to top in the reactor, through a lamellar settling system. The use of a system of membrane filtration modules is not mentioned therein.

The invention aims to overcome drawbacks of the prior art recalled above by proposing an installation for improving the membrane filtration capacity and reducing water losses, without increasing the floor area thereof.

The applicant has in fact noted, surprisingly to those skilled in the art, that this filtration capacity is improved when the membranes are placed directly in a pulsed sludge blanket coagulation/flocculation/decantation settling tank.

In such a settling tank, described, for example, in documents FR-1 115 038 and FR-2 132 954, the effluent to be treated circulates from bottom to top through a sludge blanket formed from coagulated and flocculated matter in suspension, the blanket promoting initiation of the coagulation, agglomerating and retaining the precipitates formed and the suspended matter contained in the effluent to be treated. Due to the large amount of suspended matter in the settling tank, the membrane filtration is generally carried out downstream, in a separate installation, in order to avoid any risk of membrane fouling, as described above.

The applicant has noted that, when submerged in such a settling tank, the membranes effectively become covered with matter that forms a filtration cake. However, instead of degrading the filtration capacity of the membrane, the presence of the cake, on the contrary, provides protection for the membrane. The filtration cake formed is in fact porous and slightly compressed, effectively creating a resistance to the given filtration, but protecting the membrane in relation to the fouling capacity of the interstitial water, in particular in the presence of high concentrations of colloidal or dissolved matter that is partially coagulated, or even noncoagulated. This matter is then adsorbed onto the protective layer formed. The applicant has also noted that this adsorption can, in addition, be improved by adding adsorbent reagents, for example activated carbon, making it possible to increase the adsorbent capacity of the filtration cake. A similar phenomenon is also observed in the case of the addition of a flocculation adjuvant, which promotes flocculation and control of the cohesion coefficient k of the sludge blanket, but an excess of which can cause membrane fouling. In the present case, the excess flocculation adjuvant is retained by the filtration cake, thus protecting the membrane.

Thus, unexpectedly, the specific characteristics of the flocculated sludge, in a pulsed sludge blanket, make it possible to improve the performance levels of the submerged membranes. It is therefore observed that the limiting filtration flux J_{F} of the membranes no longer follows the conventional theory of the mass flux (formula (1)), but also depends on the cohesive nature of the flocculated sludge in the settling tank:
mass flux=f(concentration of SM, J_{F}, MF, k), (2)
where k is the cohesion coefficient of the sludge and characterizes the pulsed sludge blanket settling, and MF represents the mass flux characteristic of plug-flow settling of sludge.

The membrane filtration, due to the presence of the filtration cake, can then be carried out at higher fluxes without a risk of substantial fouling.

A first subject of the invention relates to an installation for treating liquid effluents, in particular water, comprising a pulsed sludge blanket settling tank comprising:

a settling bath equipped, at its base, with a device for dispensing the effluents to be treated, arranged and placed so as to cause a homogeneous feed over the entire surface of the bath, and provided with a system for extracting the sludge formed,

an effluent feed system, upstream of the dispensing device, provided with a pulse-generating device for varying the flow rate of effluents entering the bath,

at least one membrane filtration module located above the dispensing device, so as to be submerged when the installation operates, and

a system for extracting the effluents treated by means of the filtration module(s), which system is connected, downstream, to the latter,

this installation being characterized in that it comprises at least one membrane filtration module located above the device for dispensing the effluents to be treated, so as to be submerged when the installation operates, and in that the system for extracting the effluents treated is connected, downstream, to the filtration module(s).

Another subject of the invention relates to a method for clarification, by means of coagulation, flocculation and settling, and for membrane filtration of effluents loaded with suspended matter and/or colloidal matter and/or dissolved matter, in particular raw water, in which the effluents to be treated are continuously introduced with a pulsed variable flow rate into the bath of a treatment installation according to the invention.

The use of a pulsed sludge blanket settling tank makes it possible to implement a simple and effective dispensing system: the periodic overspeeds caused by the pulsing system make it possible to dispense the effluent to be treated under the set of filtration modules, in an equilibrated manner. No imbalance in the functioning of the various membranes is thus observed, unlike the direct membrane coagulation described above. Furthermore, the pulses or overspeeds applied to the effluent to be treated, when it enters the settling bath, create, at the level of the membranes of the modules, a tangential speed that is variable over time. This method of pseudotangential filtration induced in the filtration modules limits the fouling of the membranes during the filtration. Furthermore, during the filtration, the pulses generate fluctuations in the filtration flux, thus ensuring the formation of a heterogeneous filtration cake that would be more readily removed by hydraulic antifouling.

Other characteristics and advantages of the invention will emerge from the description given hereinafter with reference to the attached, nonlimiting, drawings in which:

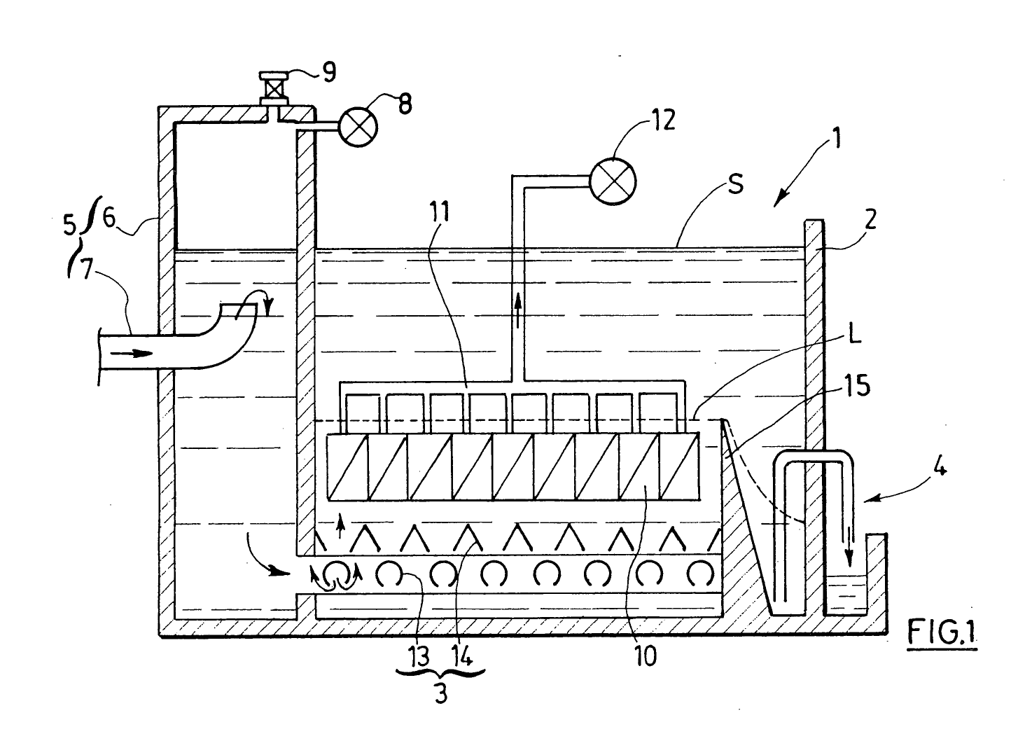

FIG. 1 is a sectional schematic representation of an embodiment of the invention;

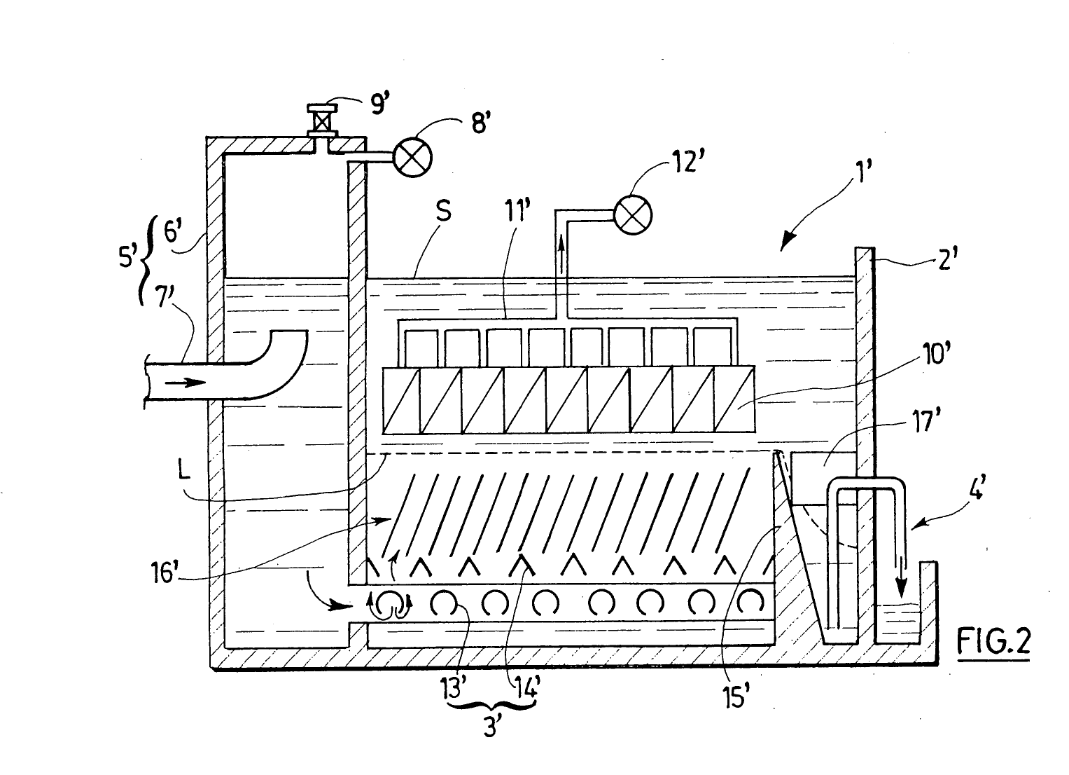

FIG. 2 is a similar representation of a variant of implementation.

The installation according to the invention comprises a settling tank 1 comprising a settling bath 2 equipped, at its base, with an effluent-dispensing device 3, and provided with a system for extracting the sludge formed 4.

An effluent feed system 5, upstream of the dispensing device 3, is provided with a pulse-generating device 6 fed with effluent to be treated by means of a pipe 7. This pulse-generating device 6 makes it possible to carry out the pulsed introduction of the effluent into the bath 2. It is, for example, a known vacuum bell jar system in which a vacuum pump 8 and a valve 9 make it possible, respectively, to raise the level of the effluent in the bell jar and to abruptly empty it, as described in document FR-1 115 038.

Several membrane filtration modules 10 are located above the distributing device 3, and are arranged so as to be submerged when the installation operates.

The membranes used in the modules can be chosen from membranes with a planar, tubular, spiral or hollow-fiber configuration, with an outer or inner skin.

Each module 10 is connected, downstream, to an extraction system 11, for example made up of pipes, by which the treated effluents are evacuated, for example by means of a pump 12.

The dispensing device 3 is made up of a network of perforated pipes 13 that extend over the entire surface of the bath, and of deflectors 14 located above and in proximity to the perforated pipes 13.

The periodic overspeeds caused by the pulsing system 6 make it possible to dispense the effluent to be treated in the network of pipes 13 positioned under the set of filtration modules 10. These pulses create turbulences, the energy of which is dissipated by the deflectors 14. Part of this dissipated energy contributes to the realization of the flocculation. The residual energy makes it possible to keep the sludge blanket homogeneous, in accordance with the cohesion parameter k.

The sludge extraction system 4 also comprises a sludge concentrator 15 of known type, preferably by means of settling.

The installation is more particularly intended for methods of clarification by means of coagulation/flocculation/settling. When it operates, a sludge blanket forms between the network of perforated pipes 13 and deflectors 14, and the overflow level into the sludge concentrator 15. This zone forms a treatment zone in which a coagulation/flocculation is carried out by contact with the sludge, allowing optimal purification of the interstitial water and decreasing its fouling capacity in relation to the membranes. Above the sludge blanket there is a settling zone, containing fewer particles in suspension. The dash line L on the figures symbolizes the limit between these zones, this limit being, of course, less marked in reality. The line S represents the interface between the settling zone and the air.

In the variant represented in FIG. 1, the modules 10 are located in the lower part of the bath 2, in proximity to the dispensing system 3, so as to be in the treatment zone. They are therefore entirely submerged in the sludge blanket and are located above the dispensing system 3.

Another variant is represented in FIG. 2: the identical elements are denoted by the same references with a prime (′). In this variant, the settling tank 1′ also has a lamellar settling system 16′ placed in the lower part of the bath so as to be submerged in the treatment zone during operation. It involves, for example, inclined plates arranged parallel to one another, as described in document U.S. Pat. No. 5,143,625. The installation also comprises, in addition, a cross-flow lamellar concentrating device 17′ at the inlet of the concentrator 15′.

In this variant, the membrane filtration modules 10′ are located above this lamellar settling system 16′ and therefore above the treatment zone, in the settling zone. Depending on the room occupied by the settling system 16′, the modules may optionally be partly in the treatment zone and partly in the settling zone.

When the installation operates, the effluent to be treated, for example raw water, enters into the pulse-generating system 6, 6′, and is then dispensed over the entire surface of the bottom of the bath 2, 2′, by virtue of the dispensing system 3, 3′. Next, the raw water circulates from bottom to top in the bath, passing through, where appropriate, the lamellar settling device 16′, and penetrates into the filtration modules 10, 10′. The water leaving the modules, filtered by the membranes, is evacuated via the evacuation system 11, 11′ by means of the pump 12, 12′. Simultaneously, the sludge formed is extracted at the level of the sludge concentrator 15, 15′. The latter 15, 15′ thus limits the height of the sludge blanket and makes it possible to significantly reduce water losses by increasing the concentration of the sludge extracted by a factor of 2 to 20 compared with the concentration of the sludge blanket. The use, at its inlet, of the concentrating system 17′ makes it possible to further increase the concentration of the sludge extracted: the sludge “rolling” on the lamellar device dehydrates, thus increasing its limiting mass flux. The direction of circulation of the effluent and of the sludge is symbolized by the arrows on the figures.

The management of the sludge extractions is, for example, based on periodic flushing lasting a few seconds, typically from 15 to 90 seconds, every 15 to 90 minutes. The frequency and the duration of the flushing can be adjusted to the volume of sludge present in the concentrator, or to its concentration, by having the extraction servo-controlled via the signal from a sensor (not represented) which is present in the concentrator and which measures the level or the concentration, and comparing these data to a set value.

Of course, the cross-flow lamellar concentrating device 17′ can also be provided for in the installation represented in FIG. 1.

Preferably, the effluent is introduced into the installation at a high flow rate for very brief periods of between approximately 5 and 20 seconds, separated by relatively long periods of time of between approximately 30 and 180 seconds, during which the effluent flow rate is low and substantially constant.

Advantageously, the high effluent flow rate is chosen so as to obtain flow speeds in the bath of between approximately 2 and 30 m³ per hour and per square meter of bath surface area, and preferably of between 4 and 18 m³·m⁻²·h⁻¹.

Advantageously, inorganic and/or organic coagulants, and/or flocculation agents, and/or adsorbent reagents can be added to the effluent when it is introduced into the installation (for example, by means of a valve not shown). Examples of inorganic coagulants are iron chloride, sulfate or chlorosulfate derivatives, aluminum chloride, sulfate or chlorosulfate derivatives, or other derivatives. The adsorbent reagents used are, for example, powdered activated carbon. Other examples of reagents are cited in “Mémento Technique de l'Eau” [Technical Handbook on Water], edited by DEGRÉMONT in 1992, page 224.

It is also preferable to periodically carry out a momentary reversal of the direction of permeation of the membrane filtration modules in order to perform antifouling of the membranes. Such a hydraulic antifouling is, for example, typically carried out every two or three days, and can be controlled as a function of measurements of charge or flux losses in the modules, or of any other appropriate parameter. The fouling of the membranes can also be limited by sending a stream of gas, generally air, through the membranes during the filtration or during the antifouling.

### EXAMPLE

An example of implementation of an installation according to the invention will now be described. This example refers to trials which were carried out on relatively charged river water, which could not be treated by direct membrane filtration while ensuring sufficient removal of organic material, and which therefore required pretreatment by coagulation.

The characteristics of the raw water treated are the following:
temperature of between 12 and 15° C.
turbidity: 5 to 15 NTU
total organic carbon: 5 to 7 mg/l
dissolved organic carbon: 4.5 to 6 mg/l.
   The concentration of suspended matter at the installation inlet is approximately 25 mg/l.

For this trial, an installation of 5 m³/h of the type illustrated by FIG. 1, equipped with submerged ultrafiltration membrane modules and also comprising an injection of coagulant with an on-line mixer (not represented) within the feed system 5, was used.

The coagulant used in the trials is ferric chloride, at a treatment rate of 30 mg/l, on a pure product basis.

The concentration in the sludge blanket is approximately 500 mg/l of suspended matter.

The coefficient k measured in the sludge is 0.8; the MF is 5.

The average settling rate in the bath during the trial is 4 m³ per hour and per square meter of surface area of the bath, for a maximum rate during the pulses of 30 m³·m⁻²·h⁻¹, making it impossible to ensure that the membranes operate in the pseudotangential filtration mode.

The pulses make it possible to maintain, in this example, an average filtration flux of 60 l·h⁻¹·m⁻² at 20° C. with a flux variation of more or less 5 l·h⁻¹·m⁻² (with a frequency of approximately one pulse every minute).

The conversion rate obtained is 99% for a concentration of 2.5 g/l of suspended matter at extraction (concentration brought to 5 g/l with the use of a cross-flow lamellar concentrating system at the inlet of the concentrator), i.e. a filtered net flux of 59 l·h⁻¹·m⁻² at 20° C.

By way of comparison for demonstrating the advantage of this method, the results obtained during the direct submerged membrane coagulation of this raw water make it possible to achieve a maximum flux of 45 l·h⁻¹·m⁻² at 20° C. for a conversion rate of 91%, i.e. a filtration net flux of 41 l·h⁻¹·m⁻² at 20° C.

In an installation that couples a pulsed sludge blanket settling tank (therefore with a purification of the interstitial water similar to that obtained on the combined device) upstream of a membrane filtration installation, the flux applied is 50 l·h⁻¹·m⁻² at 20° C. with a conversion rate of 96%, i.e. a filtration net flux of 48 l·h⁻¹·m⁻² at 20° C.

Thus, the installation according to the invention can operate with a 30% gain in net flux compared to a direct submerged membrane coagulation, and with a 19% gain in net flux compared with the coupling of two separate installations for, firstly, coagulation/settling and, secondly, membrane filtration. In terms of gain in floor area, the solution according to the invention makes it possible to divide by 3 the amount of floor space taken up by the installation, compared with the coupling of two separate installations.

What is claimed is:

1. An installation for treating liquid effluents, in particular water, this installation comprising a pulsed sludge blanket settling tank (1, 1′) comprising:
a settling bath (2, 2′) equipped, at its base, with a device for dispensing (3, 3′) the effluents to be treated, arranged and placed so as to cause a homogeneous feed over the entire surface area of the bath, and provided with a system for extracting (4, 4′) the sludge formed,
an effluent feed system (5, 5′), upstream of the dispensing device, provided with a pulse-generating device (6, 6′) for varying the flow rate of effluents entering the bath,
and a system for extracting the effluents treated,
this installation being characterized in that it comprises at least one membrane filtration module (10, 10′) located above the device for dispensing the effluents to be treated, so as to be submerged when the installation operates, and in that the system for extracting (11, 11′) the effluents treated is connected, downstream, to the filtration module(s) (10, 10′).

2. The treatment installation as claimed in claim 1, characterized in that the membrane filtration module(s) (10, 10′) is (are) located in the lower part of the bath, in proximity to the dispensing device, so as to be submerged in the treatment zone formed by the sludge blanket during operation.

3. The treatment installation as claimed in claim 1, characterized in that it comprises, between the dispensing device (3′) and the membrane filtration module(s) (10′), a lamellar settling system (16′) placed in the lower part of the bath so as to be submerged in the treatment zone during operation.

4. The treatment installation as claimed in one of claims 1 to 3, characterized in that the sludge extraction system (4, 4′) is provided with a sludge concentrator (15, 15′), the inlets of which may or may not be coupled to a cross-current lamellar concentrating system (17′).

5. The treatment installation as claimed in one of claims 1 to 4, characterized in that the device for dispensing (3, 3′) the effluents in the bath is made up of a series of perforated pipes (13, 13′) extending substantially over the entire bottom of the bath, and of deflectors (14, 14′) located above and in proximity to the perforated pipes.

6. A method for clarification, by means of coagulation, flocculation and settling, and for membrane filtration of effluents charged with suspended matter and/or colloidal matter and/or dissolved matter, in particular raw water, characterized in that the effluents to be treated are continuously introduced with a pulsed variable flow rate into the bath (2, 2′) of a treatment installation as claimed in one of the preceding claims.

7. The method as claimed in claim 6, characterized in that the effluents are introduced at a high flow rate for very brief periods of between approximately 5 and 20 seconds, separated by relatively long periods of time of between approximately 30 and 180 seconds, during which the effluent flow rate is low and substantially constant.

8. The method as claimed in claim 7, characterized in that the high effluent flow rate is chosen so as to obtain flow speeds in the bath of between approximately 2 and 30 m³ per hour and per square meter of bath surface area.

9. The method as claimed in claim 8, characterized in that the flow rate is chosen so as to obtain flow speeds in the bath of between approximately 4 and 18 m³ per hour and per square meter of bath surface area.

10. The method as claimed in one of claims 6 to 9, characterized in that the direction of permeation of the membrane filtration modules is periodically and momentarily reversed in order to carry out antifouling.

11. The method as claimed in one of claims 6 to 9, characterized in that inorganic and/or organic coagulants, and/or flocculation agents, and/or adsorbent reagents are added to the effluents when they are introduced into the installation.
